(19) United States
(12) Patent Application Publication
(10) Pub. No.: US 2004/0100362 A1
(43) Pub. Date: May 27, 2004

(54) Method and apparatus for secure data entry using multiple function keys

(76) Inventors: Magdi Mohamed, Schaumburg, IL (US); Mark Tarlton, Barrington, IL (US)

Correspondence Address: MOTOROLA INC, 600 NORTH US HIGHWAY 45, ROOM AS437, LIBERTYVILLE, IL, 60048-5343, US

(21) Appl. No.: 10/305,885

(22) Filed: Nov. 27, 2002

(51) Int. Cl. G06F 7/04

(52) U.S. Cl. 340/5.82; 340/5.83; 382/124

(57) ABSTRACT

A method and apparatus for secure data entry by sensing biometric information and determining a desired data based on the biometric information. The method can include sensing a biometric characteristic of an object, generating an expression by associating the biometric characteristic with enrollment data, the expression identifying at least a portion of a specific finger unique to a individual user of the multipurpose input device, determining positional information corresponding to a source location of the biometric characteristic, and generating a token representing a desired data entry based on the expression and the positional information. The positional information or the expression can indicate a subset of a set of potential data entry values and the combination of the positional information and the expression can uniquely define the token representing a desired data entry of the subset of potential data entry values.

### BACKGROUND OF THE INVENTION

1. Field of Invention

The present invention is directed to a method and apparatus for secure data entry using multiple function keys. In particular, the present invention is directed to a method and apparatus for sensing biometric information and determining a desired data entry based on the sensed biometric information.

2. Description of Related Art

Presently, increased functionality is desired from data entry devices. For example many functions are desired from a limited input data entry device. These data entry devices may include keypads, a single button, an array of buttons, or other data entry devices. For example, single keys on a numeric keypad of a telecommunications device may be used for multiple functions. Such functions can include using a single key for entry of different characters. For example, a single key may be used for entering a number, such as “2,” along with different characters, such as “A,” “B,” and “C.” Thus, a limited number of keys on a keypad can be used to enter a greater number of characters. This ability is especially useful for entering text messages using a numeric keypad. For example, this ability allows wireless instant messaging, sending e-mail from any phone, e-commerce interfaces, and the like on a mobile phone or other devices such as ATM stations and secured doors.

Unfortunately, increasing the number of possible entries on a single key increases the complexity of using the key. For example, a single key must be pressed repetitively, or a combination of multiple keys must be pressed simultaneously, to obtain a desired character. Not only does this increase the difficulty in entering an entire message, but it also increases the time to enter the message.

One possible technique for allowing more efficient entry of text using a numeric keypad is to use language models and dictionaries. This technique attempts to anticipate the desired word that is being entered. The technique can then present a list of possible word candidates that can be selected without typing the entire word.

Unfortunately, one problem with this technique is an out of vocabulary experience. In particular, the technique cannot recognize a word that is not in the stored dictionary. For example, the technique cannot recognize unfamiliar names or abbreviations. Another problem exists in that large dictionaries can occupy large memory in a communication device. A further problem exists when a user desires to use an alphanumeric password. In particular, this technique is not secure because it must display the password for the user to determine if the correct characters are being entered. An additional problem exists in that the technique can often still require multiple key presses per character entry. Another problem exists in that different dictionaries must be used for different languages.

Thus, there is a need for improved data entry techniques using multiple function keys. In particular, there is a need for a simpler method for efficiently entering extensive data on a limited input device.

### SUMMARY OF THE INVENTION

The invention provides a method and apparatus for sensing biometric information and determining a desired data entry based on the biometric information. The method can include sensing a biometric characteristic of an object, generating an expression by associating the biometric characteristic with enrollment data, the expression identifying at least a portion of a specific finger unique to a individual user, determining positional information corresponding to a source location of the biometric characteristic, and generating a token representing a desired data entry based on the expression and the positional information. The positional information or the expression can indicate a subset of a set of potential data entry values and the combination of the positional information and the expression can uniquely define the token representing a desired data entry of the subset of potential data entry values. The set of potential data entry values can include data entry values corresponding to keypad entries for a communication device. The set of potential data entry values can also include data entry values corresponding to a sequence of data entry values. The set of potential data entry values can additionally include data entry values corresponding to phonebook entries.

The positional information can describe a movement of a finger. The positional information can also represent an angle of a finger. The positional information can additionally represent a location of a finger. The positional information can further represent a location of a single key. Different expressions can represent different fingers of an individual user. Different expressions can also represent different portions of the specific fingers unique to the individual user.

The biometric characteristic can be a fingerprint. The token can represent a specific entry of a plurality of entries available on specific key of a plurality of keys on a communication device keypad. The token can also represent at least one command for the operation of a communication device.

According to another embodiment, the present invention provides a data entry device. The data entry device can include a keypad, a biometric sensor coupled to the keypad, and a controller coupled to the biometric sensor. The controller can be configured to sense a biometric characteristic of an object, generate an expression by associating the biometric characteristic with enrollment data, the expression identifying at least a portion of a specific finger unique to a individual user of the data device, determine positional information corresponding to a source location of the biometric characteristic, and generate a token representing a desired data entry based on the expression and the positional information.

The positional information or the expression can indicate a subset of a set of potential data entry values and the combination of the positional information and the expression can uniquely define the token representing a desired data entry of the subset of potential data entry values. The set of potential data entry values can include data entry values corresponding to keypad entries for a communication device. The set of potential data entry values can also include data entry values corresponding to a sequence of data entry values. The set of potential data entry values can additionally include data entry values corresponding to phonebook entries.

The positional information can describe a movement of a finger. The positional information can also represent an angle of a finger. The positional information can additionally represent a location of a finger. The positional information can further represent a location of a single key. Different expressions can represent different fingers of an individual user. Different expressions can also represent different portions of the specific fingers unique to the individual user. The biometric characteristic can be a fingerprint. The token can represent a specific entry of a plurality of entries available on specific key of a plurality of keys on a communication device keypad. The token can also represent at least one command for the operation of a communication device.

According to another embodiment, the present invention provides a user interface unit for a communication device. The communication device can include a keypad including at least one key, the at least one key having at least two functions associated with the at least one key, a fingerprint reader coupled to the at least one key, the fingerprint reader being configured to capture a fingerprint image, a database including data related to a first fingerprint image and data related to a first function of the at least two functions, and a controller coupled to the fingerprint reader. The controller can include a fingerprint analysis module configured to analyze the fingerprint image, and a fingerprint function determination module configured to determine a function corresponding to a combination of data relating to the at least one key and data related to the first fingerprint image.

The at least two functions can include functions facilitating the input of at least two different characters associated with the at least one key. The database can include data relating to at least three fingerprint images corresponding to at least three characters associated with the at least one key. The controller can be configured to output and send to a display a sorted list of three characters associated with the at least one key. The controller can include a security module. The security module can be configured to verify a password based on a plurality of first fingerprint images associated with a plurality of keys.

Thus, among other benefits, the present invention allows the entry of different characters using one key based on sensed biometric information. The present invention also allows for increased security based on sensed biometric information. The present invention also solves the problems associated with using dictionary-based techniques. These and further benefits will become more apparent with reference to the Figures and the descriptions of the preferred embodiments.

### BRIEF DESCRIPTION OF THE DRAWINGS

The preferred embodiments of the present invention will be described with reference to the following figures, wherein like numerals designate like elements, and wherein:

FIG. 1 is an exemplary block diagram of a data entry device according to one embodiment of the invention;

FIG. 2 is an exemplary block diagram of a biometric sensor according to a preferred embodiment;

FIG. 3 is an exemplary illustration of possible fingerprint positions according to a first embodiment;

FIG. 4 is an exemplary illustration of possible fingerprint positions according to a second embodiment;

FIG. 5 is an exemplary flowchart outlining the operation of the controller according to a preferred embodiment; and

FIG. 6 is an exemplary illustration of a mobile communication device according to a preferred embodiment.

### DETAILED DESCRIPTION OF PREFERRED EMBODIMENTS

FIG. 1 is an exemplary block diagram of a data entry device 100 according to one embodiment of the invention. The data entry device 100 can be used on a telecommunications device, a personal computer, mobile communication device, or any other apparatus utilizing data entry. The data entry device 100 can include a controller 110, a biometric sensor 120, a keypad 130, and a database 140. The biometric sensor 120 may be any device capable of sensing a biometric characteristic of an object. For example, the biometric sensor 120 may be a fingerprint reader, a scanner, a heat sensing device, a pressure sensing device, or any other device capable of sensing a biometric characteristic of an object.

The keypad 130 may be an array of buttons, a group of keys, a single button or key, switches, keypad images printed on an exterior of the data entry device 100 combined with the biometric sensor 120 or another sensor, or any other device useful for inputting data. According to a preferred embodiment, the keypad 130 is an array of keys such as a numeric keypad on a telecommunications device. The database 140 may reside in a RAM, an EEPROM, an optical memory, or any other memory useful for storing data.

The database 140 can store enrollment data. In particular, the database 140 can store data related to different sensed biometric characteristics. For example, the database 140 can store different simple image characteristics relating to different fingers or different finger positions. These image characteristics may be entered into the database by the user. For example, the data entry device 100 may be trained by prompting a user to enter biometric information. The data entry device 100 can then sense the biometric information with the biometric sensor 120. The biometric information sensed during training is then stored as enrollment data in the database 140. The data entry device 100 can then prompt the user to associate the enrollment data with a particular expression. For example, the data entry device 100 can determine an intended input based on the enrollment data. Characteristics associated with different fingers can reflect different intentions of a user. For example, an index finger may represent a left character of three characters on a key. A middle finger may represent a middle character and a ring finger may represent a right character. The database 140 may also associate individual users' different biometric characteristics with enrollment data cross referenced with stored expressions. The database 140 may also store different expressions relating to different users.

In operation, the biometric sensor 120 can be used to sense a biometric characteristic of an object. The controller 110 can generate an expression by associating the biometric characteristic with enrollment data, the expression identifying at least a portion of a specific finger unique to a individual user of the data device. The controller 110 can then determine positional information corresponding to a source location of the biometric characteristic. For example, the controller 110 can determine the position of a finger to determine the finger is at a specific key on the keypad 130. This position can be determined using the biometric sensor 120 or by using buttons or keys on the keypad 130. The controller 110 can then generate a token representing a desired data entry based on the expression and the positional information.

The positional information or the expression can indicate a subset of a set of potential data entry values. For example, the set of potential data entry values can include data entry values corresponding to keypad entries for a communication device, data entry values corresponding to a sequence of data entry values, data entry values corresponding to phonebook entries, or any other useful data entry values. The combination of the positional information and the expression can uniquely define the token representing a desired data entry of the subset of potential data entry values.

The positional information can describe a movement of a finger. The positional information can also represent an angle of a finger. The positional information can additionally represent a location of a finger. The positional information can further represent a location of a single key. Different expressions can represent different fingers of an individual user. Different expressions can also represent different portions of the specific fingers unique to the individual user.

The biometric characteristic can be a fingerprint or any other biometric characteristic. The token can represent a specific entry of a plurality of entries available on specific key of a plurality of keys on the keypad 130. The token can also represent at least one command for the operation of a communication device.

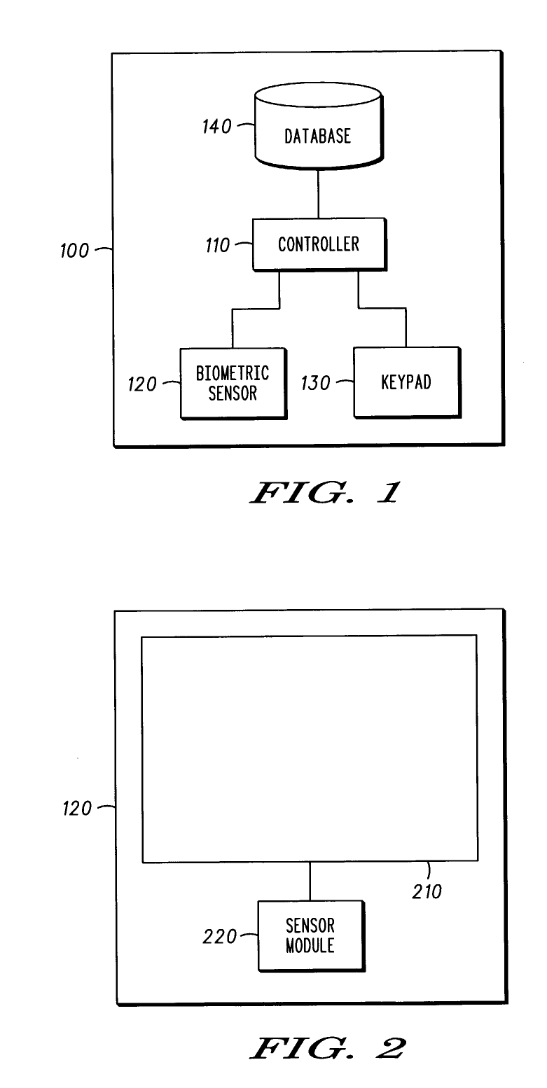

FIG. 2 is an exemplary block diagram of a biometric sensor 120 according to a preferred embodiment. The biometric sensor 120 may be a fingerprint reader, a pressure sensor, a scanner, a heat sensor, or any other device useful for sensing a biometric characteristic. The biometric sensor 120 may include a sensing surface 210 and a sensor module 220. The sensing surface 120 may provide a surface for detection of a biometric characteristic. The sensor module 220 may include algorithms or circuitry for detecting biometric characteristics at the sensing surface 120. The sensor module 220 may be incorporated into a discrete biometric sensor or may reside on the controller 110. The sensor module 220 may receive a continuous stream of data. For example, the sensor module 220 or the controller 110 may recognize a desired entry when the stream of data matches enrollment data in the database 140. As another example, the sensor module 220 may sample data upon a trigger signal. For example, the sensor module 220 may sample data when a key is pressed on the keypad 130.

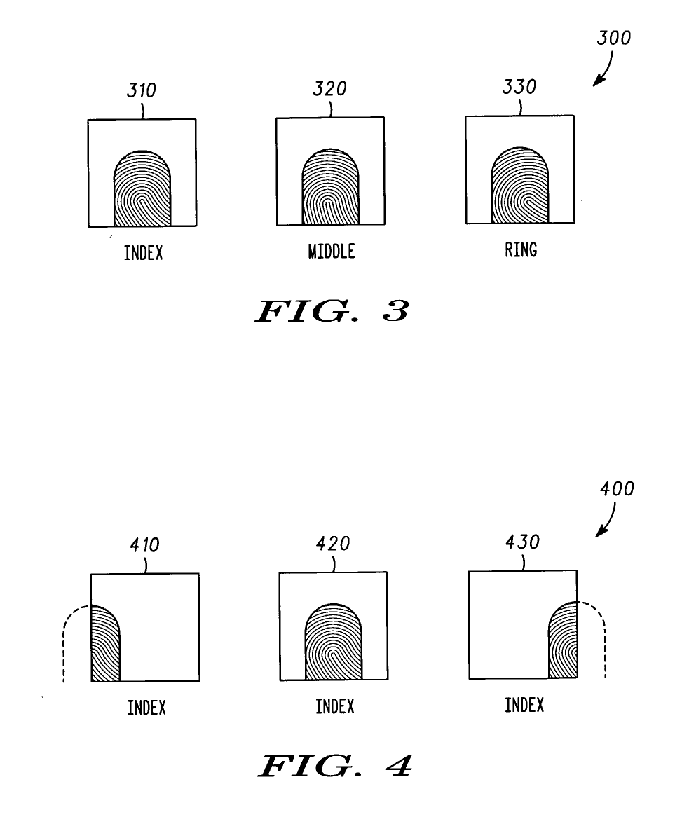

FIG. 3 is an exemplary illustration of possible fingerprint positions 300 according to a first embodiment. Biometric characteristics of these fingerprint positions 300 can be sensed at the biometric sensor 120. An expression may then be generated by the controller 110 by comparing the biometric characteristics to enrollment data stored in the database 140. An index finger 310 can be used to indicate a desire to input the left character on a key of the keypad 130. A middle finger 320 can be used to indicate a desire to input the middle character on a key of the keypad 130. A ring finger 330 can be used to indicate a desire to input the right character on a key of the keypad 130. For example, the number “2” of a numeric keypad may have the characters “A,” “B,” and “C” associated with it. The use of an index finger on the key can express the desire to input the character “A.” Similarly the use of a middle finger can be used to express the desire to input the character “B” and the use of a ring finger can be used to express the desire to input the character “C.”

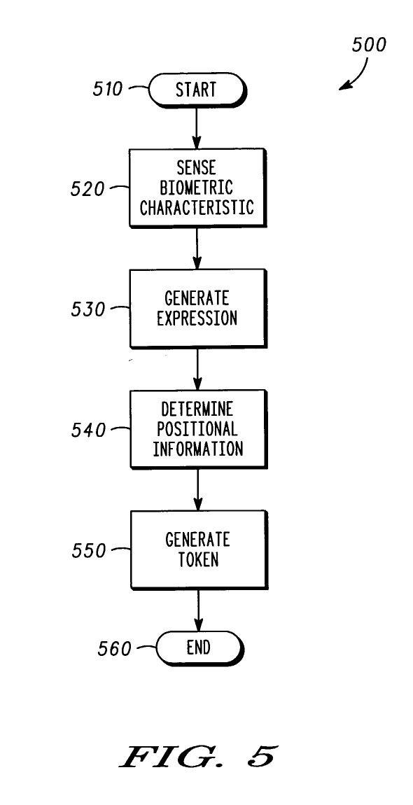

FIG. 4 is an exemplary illustration of possible fingerprint positions 400 according to a second embodiment. Biometric characteristics of these fingerprint positions 400 can be sensed at the biometric sensor 120. An expression may then be generated by the controller 110 by comparing the biometric characteristics to enrollment data. A left position 410 on a key can be used to indicate a desire to input the left character on a key of the keypad 130. A middle position 420 on the key can be used to indicate a desire to input the middle character on the key. A right position 430 on the key can be used to indicate a desire to input the right character on the key.

Because different fingers or finger positions can be used, the controller 110 may not require extensive detail of the fingerprints. In particular, the controller 110 may only require simple characteristics that distinguish each finger from the other or distinguish different finger positions. Thus, extensive scanning of a fingertip is not necessary and only a quick tap of a key or button is required. Different finger movements, strokes, or angles can also be sensed to distinguish different expressions. Thus, the controller 110 can identify different finger parts, different fingers, different angles, or different movements corresponding to a desired expression of a user.

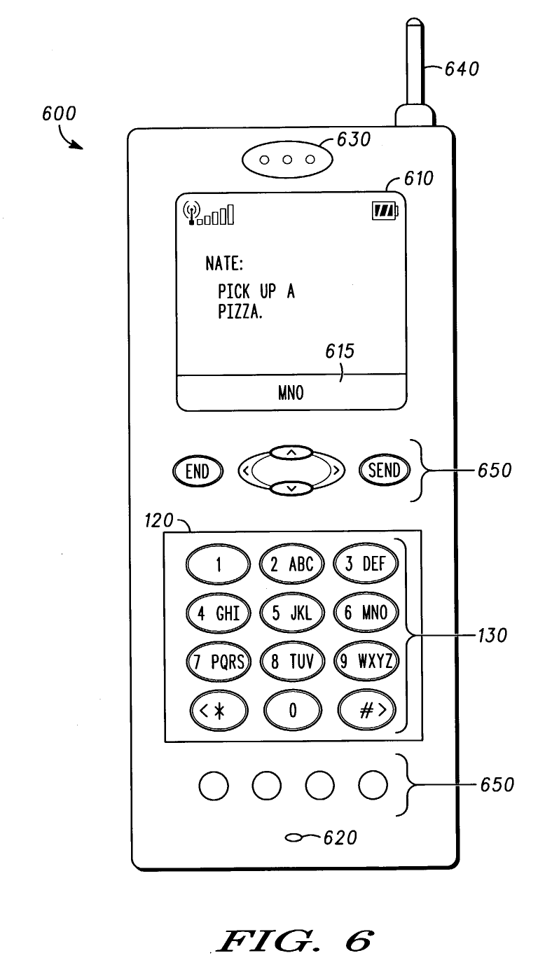

FIG. 5 is an exemplary flowchart 500 outlining the operation of the controller 110 according to a preferred embodiment. In step 510, the flowchart begins. In step 520, the controller 110 senses a biometric characteristic of an object. For example, the controller 110 may sense a fingertip using the biometric sensor 120. In step 530, the controller 110 generates an expression by associating the biometric characteristic with enrollment data. The expression can identify at least a portion of a specific finger unique to a individual user of the data entry device 100. In step 540, the controller 110 determines positional information corresponding to a source location of the biometric characteristic. In step 550, the controller generates a token representing a desired data entry based on the expression and the positional information.

As described above, the positional information or the expression can indicate a subset of a set of potential data entry values. For example, the set of potential data entry values can include data entry values corresponding to keypad entries for a communication device, data entry values corresponding to a sequence of data entry values, data entry values corresponding to phonebook entries, or any other data entry values. The combination of the positional information and the expression can uniquely define the token representing a desired data entry of the subset of potential data entry values.

The positional information can describe a movement of a finger. The positional information can also represent an angle of a finger. The positional information can additionally represent a location of a finger. The positional information can further represent a location of a single key. Different expressions can represent different fingers of an individual user. Different expressions can also represent different portions of specific fingers unique to the individual user.

The biometric characteristic can be a fingerprint. The token can represent a specific entry of a plurality of entries available on specific key of a plurality of keys on a communication device keypad. The token can also represent at least one command for the operation of a communication device. Because the data entry device 100 provides for more efficient and simpler data entry, the data does not have to be displayed while being entered. Thus, the data entry device 100 provides increased security for the entry of alphanumeric passwords.

FIG. 6 is an exemplary illustration of a mobile communication device 600 according to a preferred embodiment. The mobile communication device 600 can include the biometric sensor 120 such as a fingerprint reader, the keypad 130, a display 610, a microphone 620, a speaker 630, an antenna 640, and tactile inputs 650. The biometric sensor 120 may be a single sensor used for all keys on the keypad 130, may be multiple individual sensors with one for each key, or may be a variant thereof.

In operation the display 610 displays information such as data entries and messages. At the bottom 615 of the display 610, the sorted characters can be displayed so that the user can scroll to the left or to the right to choose an alternative character in case of mistakes due to a user miss-press or controller recognition errors. The microphone 620 provides for audible input and the speaker 630 provides for audible output of the mobile communication device 600. The antenna 640 provides for transmission and reception of mobile communication signals to and from the mobile communication device 600. The tactile inputs 650 provide for data entry in addition to the keypad 130. For example, one of the additional inputs 650 can be used for switching between numeric and alphabetic modes. Other additional inputs 650 can be used for selecting different character sets other than Latin characters to be used for different languages.

A mobile communication device controller may be coupled to the fingerprint reader 120. The mobile communication device controller can include a fingerprint analysis module configured to analyze a sensed fingerprint image and a fingerprint function determination module configured to determine a function corresponding to a combination of data relating to a key of the keypad 130 and data related to the fingerprint image.

The first function can include functions facilitating the input of at least two different characters associated with the key. A database of the mobile communication device 600 can include data relating to at least three fingerprint images corresponding to at least three characters associated with the key. A mobile communication device controller can be configured to output and send to the display 615 a sorted list of three characters associated with the at least one key. The mobile communication device controller can include a security module, the security module being configured to verify a password based on a plurality of first fingerprint images associated with a plurality of keys.

The biometric sensor 120 provides for sensing biometric information. The mobile communication device 600 can then use the controller 110 and/or the mobile communication device controller and other features of the data entry device 100 to determining a desired data entry based on the sensed biometric information

The method of this invention is preferably implemented on a programmed processor. However, the controller 110 may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this invention.

While this invention has been described with specific embodiments thereof, it is evident that many alternatives, modifications, and variations will be apparent to those skilled in the art. For example, various components of the embodiments may be interchanged, added, or substituted in the other embodiments. Accordingly, the preferred embodiments of the invention as set forth herein are intended to be illustrative, not limiting. Various changes may be made without departing from the spirit and scope of the invention. For example, instead of storing, in the database 140, all the enrollment data to be used for fingerprint recognition using a template matching technique as previously described, when using certain pattern recognition techniques only a mathematical structure of discriminant functions obtained by training the controller 110 using the enrollment data can be stored resulting in efficient memory use and improved classification accuracies.

What is claimed is:

1. A method for data entry using a multipurpose input device having a sensor comprising:
sensing a biometric characteristic of an object;
generating an expression by associating the biometric characteristic with enrollment data, the expression identifying at least a portion of a specific finger unique to a individual user of the multipurpose input device;
determining positional information corresponding to a source location of the biometric characteristic; and
generating a token representing a desired data entry based on the expression and the positional information.

2. The method according to claim 1, wherein the positional information describes a movement of a finger.

3. The method according to claim 1, wherein the positional information represents an angle of a finger.

4. The method according to claim 1, wherein the positional information represents a location of a finger.

5. The method according to claim 1, wherein the positional information represents a location of a single key.

6. The method according to claim 1,
wherein the positional information corresponds to a subset of a set of potential data entry values, and
wherein a combination of the positional information and the expression uniquely define the token representing a desired data entry of the subset of potential data entry values.

7. The method according to claim 6, wherein the set of potential data entry values include data entry values corresponding to keypad entries for a communication device.

8. The method according to claim 6, wherein the set of potential data entry values include data entry values corresponding to a sequence of data entry values.

9. The method according to claim 6, wherein the set of potential data entry values include data entry values corresponding to phonebook entries.

10. The method according to claim 1, wherein different expressions represent different fingers of an individual user.

11. The method according to claim 1, wherein different expressions represent different portions of the specific fingers unique to the individual user.

12. The method according to claim 1, wherein the biometric characteristic is a fingerprint.

13. The method according to claim 1, wherein the token represents a specific entry of a plurality of entries available on specific key of a plurality of keys on a communication device keypad.

14. The method according to claim 1, wherein the token represents at least one command for the operation of a communication device.

15. A data entry device, comprising:
a keypad;
a biometric sensor coupled to the keypad; and
a controller coupled to the biometric sensor, the controller configured to sense a biometric characteristic of an object at the biometric sensor, generate an expression by associating the biometric characteristic with enrollment data, the expression identifying at least a portion of a specific finger unique to a individual user of the data entry device, determine positional information corresponding to a source location of the biometric characteristic, and generate a token representing a desired data entry based on the expression and the positional information.

16. The data entry device according to claims 15,
wherein the positional information indicates a subset of a set of potential data entry values, and
wherein a combination of the positional information and the expression uniquely define the token representing a desired data entry of the subset of potential data entry values.

17. The data entry device according to claims 16, wherein the set of potential data entry values include data entry values corresponding to keypad entries for a communication device.

18. The data entry device according to claims 16, wherein the set of potential data entry values include data entry values corresponding to a sequence of data entry values.

19. The data entry device according to claims 16, wherein the set of potential data entry values include data entry values corresponding to phonebook entries.

20. The data entry device according to claims 15, wherein the positional information describes a movement of a finger.

21. The data entry device according to claims 15, wherein the positional information represents an angle of a finger.

22. The data entry device according to claims 15, wherein the positional information represents a location of a finger.

23. The data entry device according to claims 15, wherein the positional information represents a location of a single key.

24. The data entry device according to claims 15, wherein different expressions represent different fingers of an individual user.

25. The data entry device according to claims 15, wherein different expressions represent different portions of the specific fingers unique to the individual user.

26. The data entry device according to claims 15, wherein the biometric characteristic is a fingerprint.

27. The data entry device according to claims 15, wherein the token represents a specific entry of a plurality of entries available on specific key of a plurality of keys on a communication device keypad.

28. The data entry device according to claims 15, wherein the token represents at least one command for the operation of a communication device.

29. A communication device comprising:
a keypad including at least one key, the at least one key having at least two functions associated with the at least one key;
a fingerprint reader coupled to the at least one key, the fingerprint reader being configured to capture a fingerprint image;
a database including
data related to a first fingerprint image; and
data related to a first function of the at least two functions;
a controller coupled to the fingerprint reader, the controller including
a fingerprint analysis module configured to analyze the fingerprint image; and
a fingerprint function determination module configured to determine a function corresponding to a combination of data relating to the at least one key and data related to the first fingerprint image.

30. The communication device according to claim 1, wherein the at least two functions include functions facilitating the input of at least two different characters associated with the at least one key.

31. The communication device according to claim 1, wherein the database includes data relating to at least three fingerprint images corresponding to at least three characters associated with the at least one key.

32. The communication device according to claim 1, wherein the controller is configured to output a sorted list of three characters associated with the at least one key.

33. The communication device according to claim 1, wherein the controller includes a security module, the security module being configured to verify a password based on a plurality of first fingerprint images associated with a plurality of keys.
